(19) United States
(12) Patent Application Publication
(10) Pub. No.: US 2024/0278975 A1
(43) Pub. Date: Aug. 22, 2024

(54) Delayed Release Aerosol Actuator

(71) Applicant: Ram Mofsowitz, Langhorn, PA (US)

(72) Inventor: Ram Mofsowitz, Langhorn, PA (US)

(21) Appl. No.: 18/170,300

(22) Filed: Feb. 16, 2023

(51) Int. Cl. B65D 83/20

(52) U.S. Cl. CPC B65D 83/205

(57) ABSTRACT

An aerosol container comprising an actuator having a spray initiation mechanism and a time delay activation mechanism is disclosed. The spray initiation mechanism can be engaged by a user allowing a pushing device to apply a force onto an external valve stem, moving the external valve stem downward into an internal valve stem and activating the aerosol. The time delay activation mechanism allows for a user to engage the spray initiation mechanism and move away from the aerosol container before spraying begins and can be friction based and/or pneumatic resistance based. A plurality of apertures on the top of the external valve stem are configured to dispense aerosol in even amounts in all directions in order to provide better coverage on surfaces and surrounding space by projecting the aerosol outward at various angles and distances.

### TECHNICAL FIELD

The present disclosure relates generally to an aerosol spray container.

More specifically, the present disclosure relates to an aerosol spray container having a delayed release aerosol actuator.

### BRIEF SUMMARY OF THE INVENTION

The present disclosure provides an aerosol spray container with a time delayed activation actuator that allows for a user to engage the spray initiation mechanism and move away from the aerosol container before spraying begins.

In some embodiments the aerosol spray container comprises an aerosol spray can and an actuator, the actuator comprising a housing defining an aperture and having a base attached to a lip of the can, an external valve stem that protrudes through the aperture in the top of the housing and comprising one or more apertures at the top of the external valve stem and grooves on the base of the external valve stem, O-rings that fit into the grooves of the external valve stem, a pushing device, and a spray initiation mechanism. In such embodiments, the spray initiation mechanism can be engaged by a user allowing the pushing device to apply a force between the housing and the base of the external valve stem, thus moving the external valve stem downward into an internal valve stem and activating the aerosol. In such embodiments, frictional force between the O-rings and the cavity counters the force of the pushing device, increasing the time between the user engaging the spray initiation mechanism and the activation of a spray.

In some embodiments, a pneumatic resistance structure counters the force of the pushing device to increase the time between the user engaging the spray initiation mechanism and the activation of the spray.

In some embodiments, the aerosol container comprises an aerosol spray can and an actuator, the actuator comprising a housing defining an aperture and having a base attached to a lip of the can, an external valve stem that protrudes through the aperture in the top of the housing and comprising one or more apertures at the top of the external valve stem and grooves on the base of the external valve stem, O-rings that fit into the grooves of the external valve stem, a pneumatic resistance structure defined by a chamber between the external valve stem and the housing and/or cavity and having one or more apertures, a pushing device, and a spray initiation mechanism. Similarly, in such embodiments, the spray initiation mechanism can be engaged by a user allowing the pushing device to apply a force between the housing and the base of the external valve stem, moving the external valve stem downward into an internal valve stem and activating the aerosol.

In some embodiments, the pushing device is a spring that attached between a first spring detent below the top of the housing and a second spring detent at the base of the external valve stem and is compressed.

In some embodiments, the pushing device is an elastic member attached to the top of the external valve stem and attached to the bottom of the housing and configured to pull the external valve stem towards the internal valve stem after the spray initiation mechanism is activated.

In some embodiments, the cavity widens from the top to the base and wherein the cavity is wide enough at the point where the external valve stem and the internal valve stem meet such that there is no friction between the o-rings and the cavity.

In some embodiments, the spray initiation mechanism comprises tabs on the sides of the external valve stem and slots extending outward from the aperture of the housing. The tabs on the external valve stem can be twisted such that the tabs align with the slots on the housing allowing the spring to apply a force between the housing and the base of the external valve stem, moving the external valve stem downward into the internal valve stem.

In some embodiments, the spray initiation mechanism comprises a pin or cord connected to the external valve stem. The pin and cord detachably secures the external valve stem to the housing when the aerosol can is in a pre-activation state and can be detached by the user allowing the spring to apply a force between the housing and the base of the external valve stem, moving the external valve stem downward into the internal valve stem.

In some embodiments, the external valve stem comprises a plurality of apertures sized and placed so that the aerosol is dispensed in even amounts in all directions in order to provide better coverage on surfaces and surrounding space by projecting the aerosol outward at various angles and distances.

### BRIEF DESCRIPTION OF THE DRAWINGS

This invention will be better understood with reference to the following figures which are intended to illustrate specific embodiments within the overall scope of the invention as claimed:

FIG. 1 is a perspective view of an aerosol container according to a first embodiment of the present invention;

FIG. 2 is an exploded view of the aerosol actuator of the aerosol container of FIG. 1 in relation to the aerosol can.

FIG. 3 is a front elevation view of the aerosol container of FIG. 1;

FIG. 4 is a top plan view of the aerosol container of FIG. 1;

FIG. 5 is a perspective view of an aerosol container according to a second embodiment of the present invention;

FIG. 6 is an exploded view of the aerosol actuator of the aerosol container of FIG. 5; and,

FIG. 7 is a front cross-sectional view of the aerosol container of FIG. 5 attached to a portion of a can.

### DETAILED DESCRIPTION

In the following description, to better understand the aforementioned purposes, features, and advantages of the present invention, numerous specific details are set forth in order to provide a thorough understanding of the subject matter. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed below.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

Embodiments described herein provide for an aerosol actuator that provides a delayed release of aerosol after it is activated by a user.

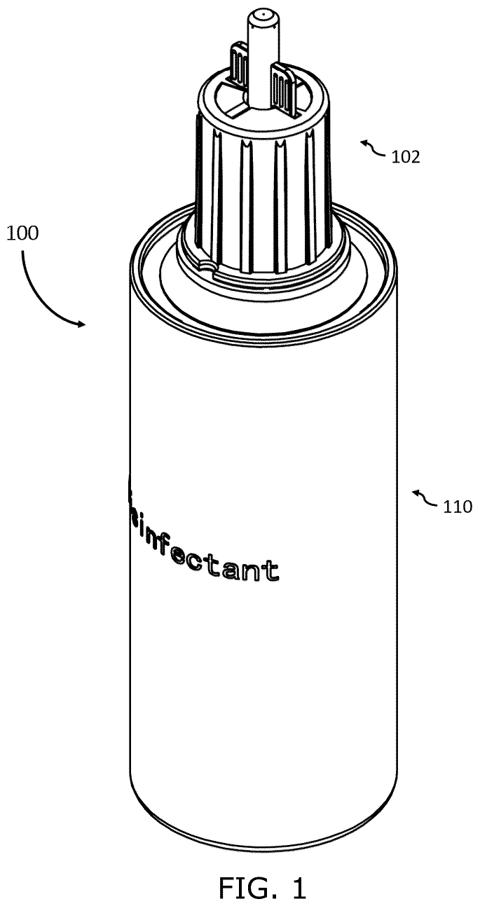

FIG. 1 is a perspective view of an aerosol container 100 having an aerosol actuator with a delayed release 102 according to an embodiment of the present invention. The aerosol container 100 includes an actuator 102 that is fixed to an aerosol can 110. The aerosol can 110 contains a spray such as disinfectant, household cleaner, or air freshener. The aerosol can 110 is configured such that it releases a spray when activated by the user. The aerosol can 110 may be made of lacquered tinplate or other materials known in the art. The actuator 102 provides mechanisms for activating and directing dispersal of the aerosol from the aerosol can 110 into the outside world.

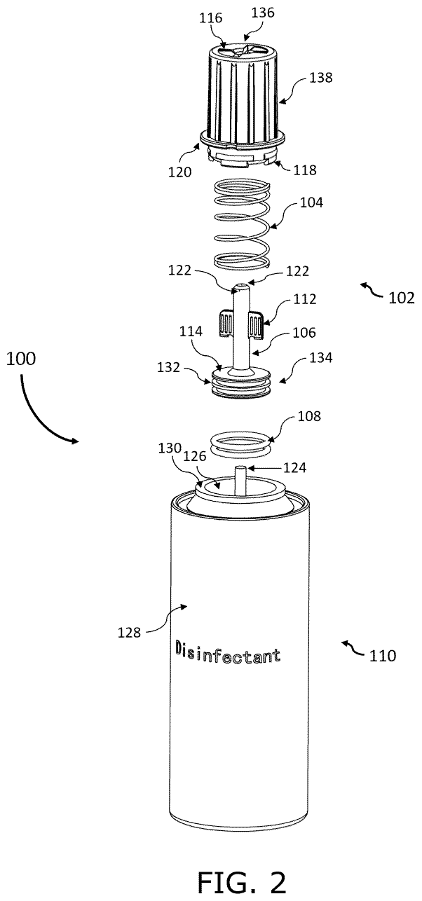

FIG. 2 is an exploded view of the aerosol actuator 102 of the aerosol container of FIG. 1 in relation to the aerosol can 110. The actuator 102 includes a time delay activation system that allows a user to manually activate the spray of aerosol and provides a delay from the time of manual activation to release of aerosol from the actuator 102. This allows a person to activate the aerosol container 100 and walk away before the spray is released. In some embodiments, the time delay activation system includes a housing 138, a spring 104, an external valve stem 106, and a pair of O-rings 108. The housing 138 is a structure that encloses the spring 104, the O-rings 108, and a portion of the external valve stem 106. The housing 138 includes a base 120 that attaches to a lip of the aerosol can 130 using attachment point 118 when assembled. In some embodiments, the housing is composed of plastic. The external valve stem 106 is a hollow tube that allows spray to flow through it once released from the aerosol can 110. The external valve stem 106 can be made of plastic or metal. A CNC machine may optionally be used to produce it. When assembled, the top portion of the external valve stem 106 extends through an aperture 136 defined in the housing 138 and the bottom portion of the external valve stem 106 remains within the housing 138. The spring 104 is a compression spring. In some embodiments, the spring 104 is made of metal. The spring 104 is positioned between the top of the housing 102 and the base of the external valve stem 134 surrounding a portion of the external valve stem 106. The pair of O-rings 108 are circular pieces typically made of rubber. The O-rings 108 are disposed within the grooves 132 in the base of the external valve stem 134.

The housing 138 defines an aperture 136, a pair of slots 116 that extend from the aperture 136, a base 120, an attachment point 118, and an internal spring detent. The internal spring detent may be the top of the housing 138 or an additional structure within the housing 138. The external valve stem 106 is disposed through the aperture 136. The external valve stem 106 has tabs 112 that allow it to rest on top of the actuator 102 when assembled. The external valve stem tabs 112 may be twisted so that they align with the slots 116 on the housing 138 and activate the aerosol container 100. When the tabs 112 and slots 116 are aligned, the spring 104 applies a force between the internal spring detent within the housing 138 and the spring detent on the external valve stem 114 causing the external valve stem to move towards the aerosol can 110 so that the base of the external valve stem 134 goes into the cavity 126 at the top of the aerosol can 110.

The spring 104 forces the base of the external valve stem 134 to contact the internal valve stem 124 of the aerosol disinfectant can. There is a hole at the base of the external valve stem 134 that is narrower than the internal valve stem 124. Thus, when contact is made between the valve stems, the internal valve stem 124 is pushed down.

When the internal valve stem 124 is pushed down, aerosol is sprayed out of the aerosol can 110 into the external valve stem 106. The structure of external valve stem 106 defines a plurality of apertures 122 at its top. In some embodiments, the plurality of apertures 122 are placed so that the aerosol is released in multiple directions in order to disperse aerosol in multiple directions. In an example, the plurality of apertures 122 are oriented and otherwise configured to project aerosol outward from the actuator 102 in generally even amounts in all directions of a 180-degree dome about the actuator 102. Thus, the aerosol is projected outward from the actuator 102 and ideally travels in a generally constant direction until the aerosol contacts a surface. In this way, all top and side surfaces in a line-of-sight from the actuator 102 can ideally be Thus, the aerosol is projected outward from the actuator 102 and ideally travels in a generally constant direction until the aerosol contacts a surface. In this way, all top and side surfaces in a line-of-sight from the actuator 102 can ideally be contacted with the aerosol. Some aerosol will also settle on upward facing surfaces and side surfaces that are not in a line-of-sight due to natural drift of the aerosol. This is in contrast with a single vertical spray in which the aerosol is projected upward to the surrounding space and most of the aerosol settles on upward facing surfaces. The actuator 102 described herein provides better coverage of side surfaces and surrounding space by projecting the aerosol outward at side angles as well as vertically upward.

In some embodiments, there are five apertures for the aerosol to exit the container. One aperture is at the top of the external valve stem 106 allowing for the aerosol to be sprayed in the vertical direction and four apertures spaced equidistant from each other on the side of the external valve stem 106 at a 90-degree angle from the external valve stem that allows for spraying in the horizontal direction. The apertures 122 may be of various diameters as to change the concentration of aerosol sprayed in various directions. Other embodiments may have a different number of apertures or have apertures with different angles relative to the external valve stem. In some embodiments there are three apertures positioned equidistantly around the sides of the external valve stem at 45-degree angles from the external valve stem.

The pair of O-rings 108 are disposed within respective grooves 132 of the external valve stem 106. The base 134 of the external valve stem 106 extends into the cavity 126 of the aerosol can 110, such that the O-rings 108 contact the sidewalls of the cavity 126. The contact between the O-rings 108 and the cavity 126 causes resistance to longitudinal movement of the external valve stem 106 into the cavity 126. The frictional force slows the movement of the external valve stem 106 providing for a time delay between the alignment of the tabs 112 and slots 116 and contact between the external and internal valve stems. This time delay allows for the user to place the aerosol spray 100 in the desired location, twist the tabs 112 so that they align with the slots 116, and be out of the range when spraying begins.

In some embodiments, the cavity 126 is wider at its base than its top. At the point where the external and internal valve stems contact each other, the cavity 126 is wide enough such that there is not friction between the O-rings 108 and the cavity 126. The lack of friction allows the spring 104 to force the external valve stem 106 into the internal valve stem 124 and release the aerosol spray. The aerosol will then spray until the can is empty and the user can retrieve it upon completion.

In other embodiments, other spray initiation mechanisms can be used. For example, although the tabs 112 on the external valve stem 106 in conjunction with the slots 116 and adjacent surfaces on the housing 138 function to hold the external valve stem 106 in a preactivated position and enable a user to manually twist the external valve stem 106 for activation, other spray initiation mechanisms may be used. The spray initiation mechanism holds the external valve stem 106 away from the internal valve stem 124 in its pre-activation state. The spray initiation mechanism also enables a user to manually (via physical contact with the actuator 102) release the external valve stem 106 so that it can come into contact with and press downward on the internal valve stem 124 to release the aerosol. In some embodiments described herein, a spring 104 functions as a pushing device, providing the force for the external valve stem 106 to contact with and press downward on the internal valve stem 124. In some embodiments, other pushing devices are used such as an elastic member attached to the top of the external valve stem and attached to the bottom of the housing and configured to pull the external valve stem 106 towards the internal valve stem 124 after the spray initiation mechanism is activated. In some embodiments, a pin or cord can be connected to the external valve stem 106 and contact or be secured to the housing 138 to hold the external valve stem 106 apart from the internal valve stem 124 in its pre-activation state. The user would pull and remove the pin or cord to activate the aerosol.

Alternative delay mechanisms in the time delay activation system may also be used. The delay mechanism can provide a force that counters the spring 104 prior to the base 134 of the external valve stem 106 reaching the internal valve stem 124. Alternative embodiments may use sources of friction other than O-rings or may use different types of forces.

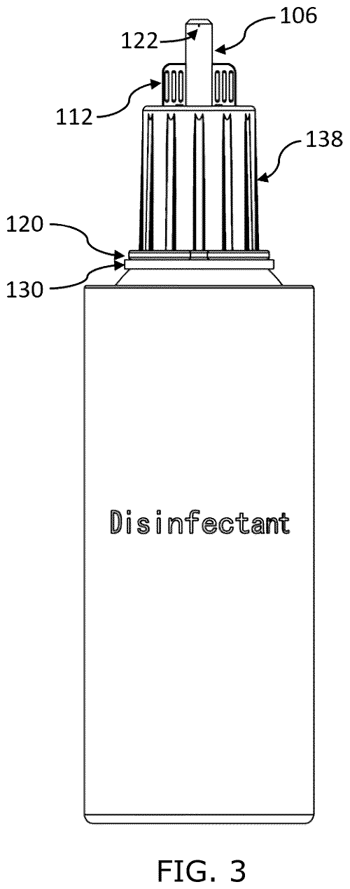

FIG. 3 is a front elevation view of the aerosol container 100 of FIG. 1. The actuator 102 and the aerosol can 110 are both visible. The base of the housing 120 is placed on the lip of the aerosol can 130. The top portion of the external valve stem 106 is visible and the tabs 112 can be seen above the top of the housing 138. One of the plurality of apertures 122 is visible at the top of the external valve stem 106.

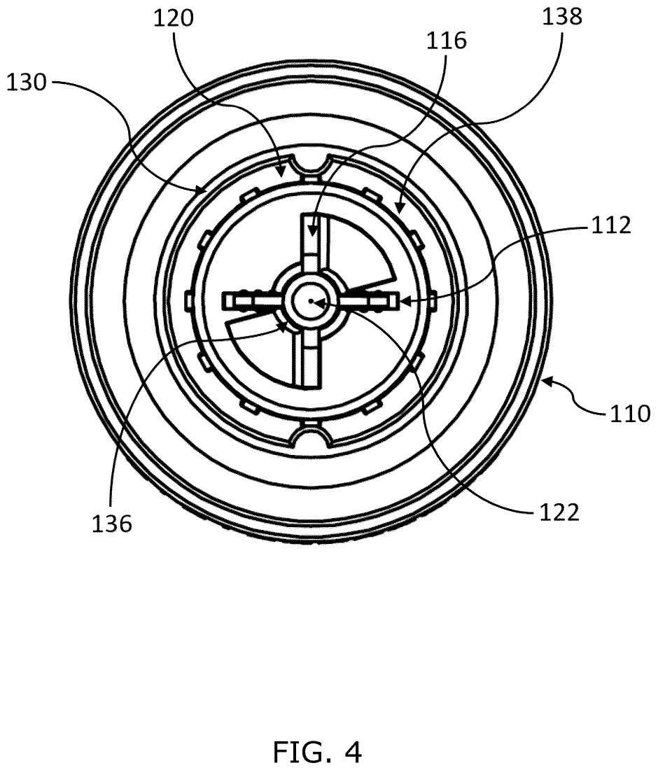

FIG. 4 is a top plan view of the aerosol container 100 of FIG. 1. The tops of the actuator 102 and the aerosol can 110 are visible. The top of the external valve stem 106 protrudes through the aperture 136 at the top of the housing 138. The tabs 112 are positioned perpendicular to the slots 116 at the top of the housing 138 so that the aerosol is not activated. The aerosol can be activated by twisting the tabs 112 counterclockwise such that the tabs are aligned with the slots 116. One of the plurality of apertures 122 is visible allowing for spray in the vertical direction at the top of the external valve stem 106. The base of the housing 120 is positioned above the lip of the aerosol can 130.

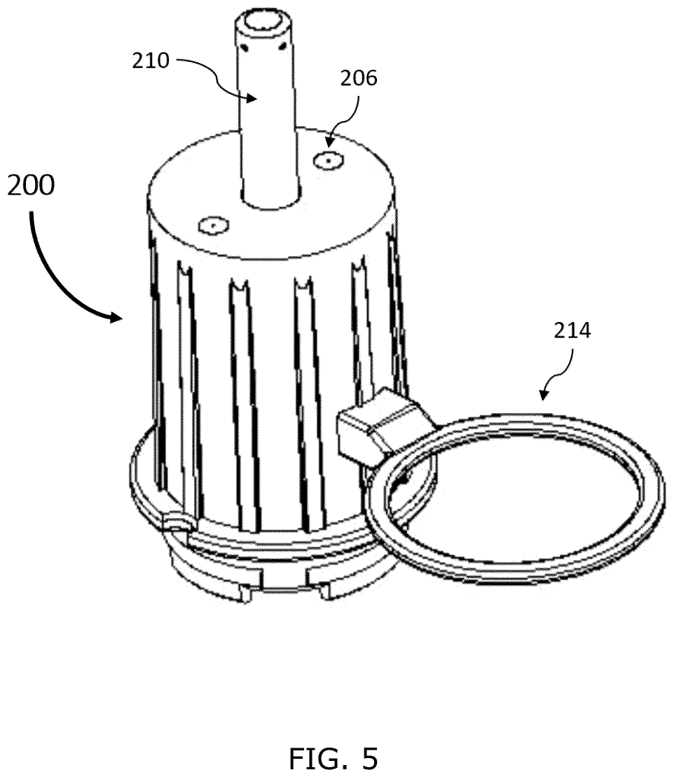

FIG. 5 is a perspective view of an aerosol container according to a second embodiment of the present invention having an activation pin 214 and a pneumatic resistance structure as the delay mechanism. The activation pin 214 can be connected to the external valve stem 210 and contact or be secured to the housing to hold the external valve stem 210 apart from the internal valve stem in its pre-activation state. The user would pull and remove the pin or cord to initiate the spraying process.

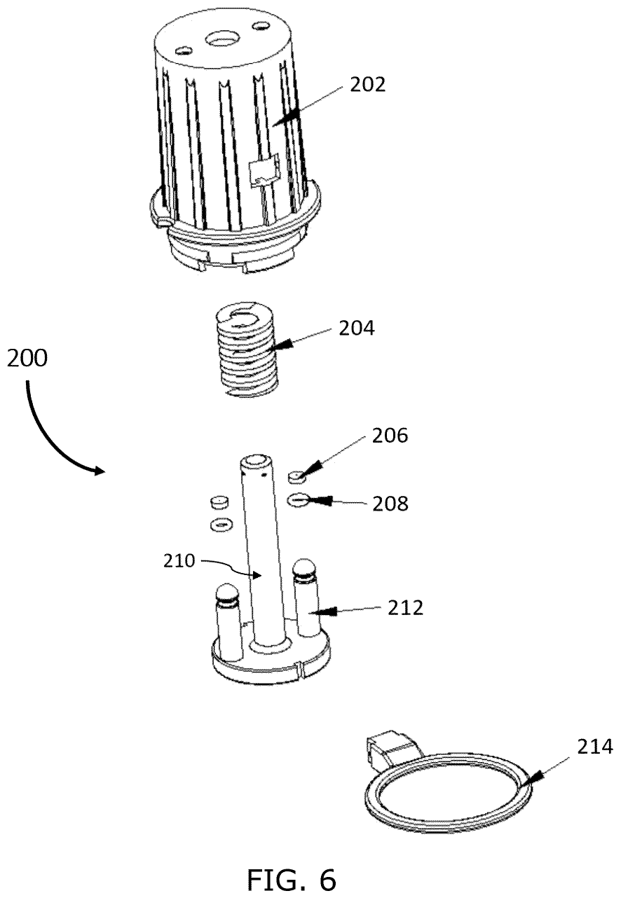

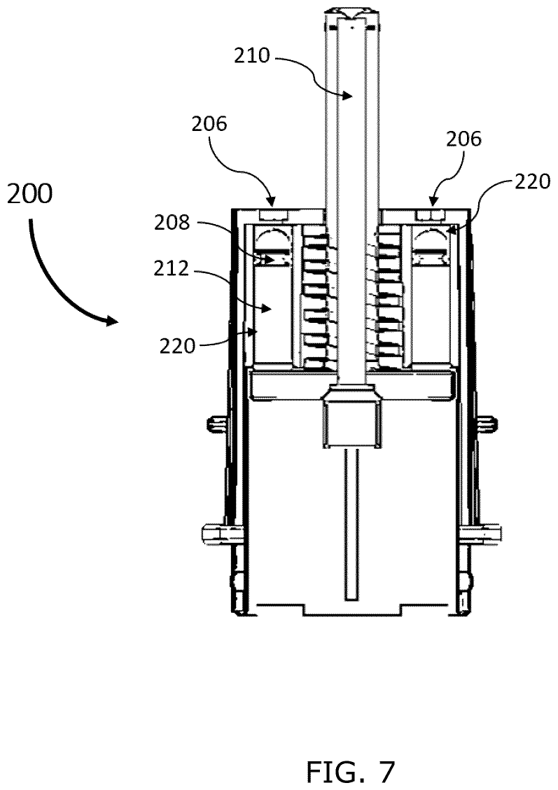

Referring to FIG. 6 and FIG. 7, an exploded view of the aerosol actuator of the aerosol container of FIG. 5 and a front cross-sectional view of the aerosol container of FIG. 5 attached to a portion of a can are respectively shown. The pneumatic resistance structure includes one or more chambers 220 defined between the external valve stem 210 and the housing 202 and/or cavity of a can. Each chamber of the one or more chambers is configured to receive a plunger 212 attached to the base of the external valve stem 210. Movement of the external valve stem 210 towards the internal valve stem (not shown) increases or decreases the size of the one or more chambers, causing air (or other fluid) to flow into or out of the chamber. The one or more chambers 220 comprise one or more apertures 206 and are configured such that the air flowing into/out of the one or more chambers 220 is forced through the one or more apertures 206. In this embodiment, the one or more apertures 206 are the holes on the vent plates 206. The plungers 212 are configured to receive sealing rings 208 such that the space between an inserted plunger 212 with an attached sealing ring 208 and the top of the chamber the plunger is inserted into is sealed if the vent plate hole is closed. The one or more apertures 206 (vent plate holes) are sized such that the force required to push the air through the apertures 206 slows the travel of the external valve stem 210 toward in the internal valve stem, thereby providing a delay time between activation and release of the aerosol. The one or more chambers 220 can also be configured such that after the external valve stem 210 comes into contact with the internal valve stem, the force against the spring provided by the pneumatic structure is reduced, allowing the net force pushing the external valve stem 210 toward the internal valve stem to increase. Specifically, the lengths of the one or more chambers 220 can be chosen so that the inserted plungers exit their respective chambers at the time that the external valve stem comes into contact with the internal valve stem, releasing the air pressure in the one or more chambers and thus removing any counter force to the force of the spring or other pushing device. This increase in net force provides sufficient force for the external valve stem 210 to overcome the resistance of the internal valve stem and push the internal valve stem downward to release the aerosol from the can.

Another alternative embodiment may use threading as a delay mechanism. After activation, the force of the spring must screw the external valve stem through the threading before it reaches the internal valve stem. The threading can stop at a point corresponding to contact between the external valve stem and the internal valve stem to provide the increase in net force discussed above.

In practice, there are a number of applications for the three-dimensional aerosol spray with delayed self-activation. One example application of the aerosol spray is for disinfecting rental cars. In this example, the aerosol is filled with disinfectant. A user can place the aerosol spray into a car, activate it, and leave the car before the aerosol begins spraying. The user can then retrieve the can upon completion.

It should also be appreciated that various modifications, adaptations, and alternative embodiments thereof may be made within the scope and spirit of the present invention.

What is claimed is:

1. An aerosol container comprising:
an aerosol spray can having a lip at the top of the can, a cavity inside the lip, and an internal value stem at the center of the cavity;
an actuator, the actuator comprising:
a housing, the housing defining an aperture and having a base attached to the lip of the can;
an external valve stem that protrudes through the aperture in the top of the housing, the external valve stem comprising:
one or more apertures at the top of the external valve stem; and,
grooves on the base of the external valve stem;
o-rings that fit into the grooves of the external valve stem;
a pushing device; and,
a spray initiation mechanism;
wherein the spray initiation mechanism can be engaged by a user allowing the pushing device to apply a force between the housing and the base of the external valve stem, moving the external valve stem downward into an internal valve stem and activating the aerosol; and,
wherein friction is caused between the o-rings and the cavity increasing the time between the user engaging the spray initiation mechanism and the activation of a spray.

2. The aerosol container of claim 1, wherein the pushing device comprises:
a first spring detent below the top of the housing;
a second spring detent at the base of the external valve stem; and,
a spring that attaches between the first spring detent and the second spring detent and is compressed.

3. The aerosol container of claim 1, wherein the pushing device comprises:
an elastic member attached to the top of the external valve stem and attached to the bottom of the housing and configured to pull the external valve stem towards the internal valve stem after the spray initiation mechanism is activated.

4. The aerosol container of claim 2, wherein the cavity widens from the top to the base and wherein the cavity is wide enough at the point where the external valve stem and the internal valve stem meet such that there is no friction between the o-rings and the cavity.

5. The aerosol container of claim 3, wherein the cavity widens from the top to the base and wherein the cavity is wide enough at the point where the external valve stem and the internal valve stem meet such that there is no friction between the o-rings and the cavity.

6. The aerosol container of claim 4, wherein the spray initiation mechanism comprises:
tabs on the sides of the external valve stem; and,
slots extending outward from the aperture of the housing;
wherein the tabs on the external valve stem can be twisted such that the tabs align with the slots on the housing allowing the spring to apply a force between the housing and the base of the external valve stem, moving the external valve stem downward into the internal valve stem.

7. The aerosol container of claim 4, wherein the spray initiation mechanism comprises:
a pin or cord connected to the external valve stem;
wherein the pin or cord detachably secures the external valve stem to the housing when the aerosol can is in a pre-activation state and can be detached by the user allowing the spring to apply a force between the housing and the base of the external valve stem, moving the external valve stem downward into the internal valve stem.

8. The aerosol container of claim 5, wherein the spray initiation mechanism comprises:
tabs on the sides of the external valve stem; and,
slots extending outward from the aperture of the housing;
wherein the tabs on the external valve stem can be twisted such that the tabs align with the slots on the housing allowing the elastic member to apply a downwards force on the base of the external valve stem, moving the external valve stem downward into the internal valve stem.

9. The aerosol container of claim 5, wherein the spray initiation mechanism comprises:
a pin or cord connected to the external valve stem;
wherein the pin or cord detachably secures the external valve stem to the housing when the aerosol can is in a pre-activation state and can be detached by the user allowing the elastic member to apply a downward force on the base of the external valve.

10. An aerosol container comprising:
an aerosol spray can having a lip at the top of the can, a cavity inside the lip, and an internal value stem at the center of the cavity;
an actuator, the actuator comprising:
a housing, the housing defining one or more apertures and having a base attached to the lip of the can;
an external valve stem that protrudes through the aperture in the top of the housing, the external valve stem having one or more first apertures at its top and one or more plungers on its base;
a pneumatic resistance structure defined by one or more chambers between the external valve stem and the housing and/or cavity, the pneumatic resistance structure having one or more second apertures and the chambers being configured to receive the one or more plungers;
a pushing device; and,
a spray initiation mechanism;
wherein the spray initiation mechanism can be engaged by a user allowing the pushing device to apply a force between the housing and the base of the external valve stem, moving the external valve stem downward into an internal valve stem and activating the aerosol; and,
wherein movement of the external valve stem towards the internal valve stem increases or decreases the size of the one or more chambers, causing the air or other fluid to flow into or out of the chambers through the one or more second apertures, the size and quantity of the one or more second apertures configured such that the force required to push the air through the one or more apertures slows the movement of the external valve stem downward into an internal valve stem, increasing the time between the user engaging the spray initiation mechanism and the activation of a spray.

11. The aerosol container of claim 10, wherein the pushing device comprises:
a first spring detent below the top of the housing;
a second spring detent at the base of the external valve stem; and,
a spring that attaches between the first spring detent and the second spring detent and is compressed.

12. The aerosol container of claim 10, wherein the pushing device comprises:
an elastic member attached to the top of the external valve stem and attached to the bottom of the housing and configured to pull the external valve stem towards the internal valve stem after the spray initiation mechanism is activated.

13. The aerosol container of claim 11, wherein the spray initiation mechanism comprises:
tabs on the sides of the external valve stem; and,
slots extending outward from the aperture of the housing;
wherein the tabs on the external valve stem can be twisted such that the tabs align with the slots on the housing allowing the spring to apply a force between the housing and the base of the external valve stem, moving the external valve stem downward into the internal valve stem.

14. The aerosol container of claim 11, wherein the spray initiation mechanism comprises:
a pin or cord connected to the external valve stem;
wherein the pin or cord detachably secures the external valve stem to the housing when the aerosol can is in a pre-activation state and can be detached by the user allowing the spring to apply a force between the housing and the base of the external valve stem, moving the external valve stem downward into the internal valve stem.

15. The aerosol container of claim 12, wherein the spray initiation mechanism comprises:
tabs on the sides of the external valve stem; and,
slots extending outward from the aperture of the housing;
wherein the tabs on the external valve stem can be twisted such that the tabs align with the slots on the housing allowing the elastic member to apply a downwards force on the base of the external valve stem, moving the external valve stem downward into the internal valve stem.

16. The aerosol container of claim 12, wherein the spray initiation mechanism comprises:
a pin or cord connected to the external valve stem;
wherein the pin or cord detachably secures the external valve stem to the housing when the aerosol can is in a pre-activation state and can be detached by the user allowing the elastic member to apply a downward force on the base of the external valve.

17. The aerosol container of claim 15, wherein the one or more first apertures are configured to allow the aerosol to be released in multiple directions in order to dispense aerosol in even amounts in all directions and to provide better coverage on surfaces and surrounding space by projecting the aerosol outward at various angles and distances

18. The aerosol container of claim 16, wherein the one or more first apertures are configured to allow the aerosol to be released in multiple directions in order to dispense aerosol in even amounts in all directions and to provide better coverage on surfaces and surrounding space by projecting the aerosol outward at various angles and distances.

19. An aerosol container comprising:
an aerosol spray can, the aerosol spray can containing a cavity inside of the lip and an internal valve stem at the center of the cavity;
an actuator attached to the aerosol spray can, the actuator comprised of:
a housing, the housing defining an aperture on top of the housing and a spring detent that is below the top of the housing;
an external valve stem that protrudes through the aperture in the top of the housing, the external valve stem containing a plurality of apertures at the top of the external valve stem and a spring detent at the base of the external valve stem;
a pneumatic resistance structure defined by a chamber between the external valve stem and the housing and/or cavity, the pneumatic resistance structure having one or more apertures;
a spring that attaches between the spring detent of the housing and the spring detent of the external valve stem and is compressed; and,
a plurality of discharge apertures system;
wherein the plurality of discharge apertures system is activated by a user by engaging a spray initiation mechanism, allowing the spring to apply a force between the housing and the base of the external valve stem moving the external valve stem downward into the internal valve stem activating the aerosol, allowing the aerosol to be released in multiple directions in order to dispense aerosol in even amounts in all directions, and to provide better coverage on surfaces and surrounding space by projecting the aerosol outward at various angles and distances; and,
wherein movement of the external valve stem towards the internal valve stem increases or decreases the size of the chamber, causing the air or other fluid to flow into or out of the chamber through the one or more apertures of the chamber, the size and quantity of the one or more apertures configured such that the force required to push the air through the one or more apertures slows the movement of the external valve stem downward into an internal valve stem, resulting in a delayed activation of a spray.

20. The aerosol container of claim 19, wherein the cavity widens from the top to the base and wherein the cavity is wide enough at the point where the external valve stem and the internal valve stem meet such that there is no friction between the o-rings and the cavity; and,
wherein the spray initiation mechanism comprises:
tabs on the sides of the external valve stem; and,
slots extending outward from the aperture;
wherein the tabs on the external valve stem can be twisted such that the tabs align with the slots on the housing allowing the spring to apply a force between the housing and the base of the external valve stem, moving the external valve stem downward into the internal valve stem.
